(19) United States
(12) Patent Application Publication
(10) Pub. No.: US 2017/0188233 A1
(43) Pub. Date: Jun. 29, 2017

(54) Dynamic Contextual Device Networks

(71) Applicant: Diro, Inc., Anaheim, CA (US)

(72) Inventor: Vishal Gupta, Delhi (IN)

(21) Appl. No.: 15/301,684

(22) PCT Filed: Apr. 10, 2015
(86) PCT No.: PCT/US2015/025436

§ 371 Date: Oct. 3, 2016

Related U.S. Application Data
(60) Provisional application No. 62/119,812, filed on Feb. 24, 2015.
(60) Provisional application No. 62/112,180, filed on Feb. 5, 2015.
(60) Provisional application No. 62/021,514, filed on Jul. 7, 2014.
(60) Provisional application No. 61/978,478, filed on Apr. 11, 2014.

(30) Foreign Application Priority Data
Jul. 21, 2014 (IN) 2051/DEL/2014

(51) Int. Cl. H04W 12/06; H04L 29/08; G06K 9/00; H04L 29/06; H04W 12/08

(52) U.S. Cl. CPC H04W 12/06; H04L 63/0861; H04L 63/0876; H04L 63/107; H04W 12/08; H04L 63/083; H04L 63/102; G06K 9/00892; H04L 67/104; H04W 84/12

(57) ABSTRACT

In one aspect, a system includes circuitry configured to establish and maintain data channels and virtual halls. Each virtual hall is associated with one of the data channels, and each virtual hall includes data and objects related to the virtual hall, where the data includes context information related to devices or users. Each virtual hall provides access to the data and objects to members of the virtual hall. Modifications to the data and objects of the virtual hall are synchronized between members of the virtual hall.

### CROSS-REFERENCE TO RELATED PATENT APPLICATIONS

This application claims the benefit of and priority to U.S. Provisional Patent Applications 61/978,478 filed Apr. 11, 2014 to Gupta, titled “Location Based Service on Mobile Devices;” 62/021,514 filed Jul. 7, 2014 to Gupta, titled “Creating and Accessing Virtual Halls using Unique Ids of Network Devices;” 62/112,180 filed Feb. 5, 2015 to Gupta, titled “Dynamic Contextual Device Network;” 62/119,812 filed Feb. 24, 2015 to Gupta, titled “Creating and Accessing Dynamic Contextual Device Networks;” and further claims the benefit of and priority to Indian application number 2051/DEL/2014 filed Jul. 21, 2014 to Gupta, titled “Context Scanner or Trigger Device.” The contents of each of these five applications are incorporated herein by reference in their entirety.

### BACKGROUND

Computing devices such as laptops, tablets and mobile phones are now widespread and an indelible part of our daily lives. However, gaining access to information can be a tedious job, particularly when a computing device is temporarily not connected to the Internet. Additionally, information that is retrieved may be relevant to an area, but may be less relevant to a particular user or the user's context.

### SUMMARY

In one aspect, a system includes circuitry configured to establish and maintain data channels and virtual halls. Each virtual hall is associated with one of the data channels, and each virtual hall includes data and objects related to the virtual hall, where the data includes context information related to devices or users. Each virtual hall provides access to the data and objects to members of the virtual hall. Modifications to the data and objects of the virtual hall are synchronized between members of the virtual hall.

In one aspect, a system includes circuitry configured to receive a virtual hall identifier and a request to create a virtual hall associated with the virtual hall identifier, create a virtual hall, establish a data channel for communication within the virtual hall, and provide a virtual insignia identifying the virtual hall. The circuitry is further configured to receive a first request from a first device, the first request initiated by selection of the virtual insignia, the first request being to add the first device to the virtual hall. The circuitry is further configured to identify a context of the first device, verify that the context of the first device is consistent with rules associated with the virtual hall, add the first device as a member of the virtual hall, provide information about the virtual hall to the first device, and update the virtual hall with information about the first device.

In one aspect, a method includes receiving a selection of a virtual insignia from a user interface of a first user device, transmitting a representation of the virtual insignia to a remote computing device, accepting from the remote computing device information related to a virtual hall associated with the virtual insignia, providing context data to the remote computing device, accepting synchronizing data related to a second user device entering the virtual hall, and submitting data for distribution to participants of the virtual hall.

In one aspect, a method includes providing location information of a user device to a remote computing device and receiving from the remote computing device a list of virtual halls. For each of the virtual halls in the list, the method includes determining a proximity of the user device to a transmitting device of the virtual hall. The method further includes prioritizing the list of virtual halls based on proximity, providing a prioritized group of virtual insignias representing the prioritized list of virtual halls to a user interface of the user device, and receiving a selection of one of the virtual insignias from the user interface.

### BRIEF DESCRIPTION OF THE DRAWINGS

FIG. 1A is a representation of an example of a network environment.

FIG. 1B is a representation of an example of a dynamic contextual device network environment.

FIG. 2 is a block diagram representation of an example of a computing device.

FIG. 3 is a flow diagram illustrating an example of context-aware access to directories.

FIG. 4 is a flow diagram illustrating an example of creating a directory.

FIG. 5 is a table diagram illustrating an example of a database structure for a dynamic contextual device network.

FIG. 6 is a flow diagram illustrating an example of context-aware access to dynamic contextual device networks.

FIG. 7 is a flow diagram illustrating an example of creating a dynamic contextual device network.

FIG. 8 is a diagram illustrating an example of a data structure for a dynamic contextual device network.

FIG. 9 is a block diagram representation of Virtual Halls.

FIG. 10 is a flow diagram illustrating an example of accessing information in a dynamic contextual device network with automatic identity verification.

FIG. 11 provides an example of a presentation of objects in a virtual hall to a graphical user interface.

### DETAILED DESCRIPTION

Described in this disclosure are user friendly and efficient techniques for discovering information based on a context of a person or a computing device, such that information obtained by the techniques described is relevant to the context. Techniques described in this disclosure can also be used for local level messaging, file or video sharing.

Context as used in this disclosure refers to data about a user or an associated computing device, such as location context, demographic context, interest context, medical need context, employment context, use context, historical context, capability context, manufacturing context, and other contexts that describe a user or an associated computing device. Examples of contexts are provided throughout this disclosure.

As described in this disclosure in overview, a dynamic contextual device network (DCDN) is defined based on a set of rules related to context of eligible computing devices or users; in other words, the rules of the DCDN describe computing devices or users that are eligible to join the DCDN based on their context. Because the DCDN is accessed by a computing device whether the context is based on a user or a computing device, a reference in this disclosure to membership or access by a computing device may represent membership or access by a user by way of a computing device.

Each DCDN may include one or more Virtual Halls. Each Virtual Hall has a corresponding Virtual Hall identifier. A computing device eligible to join a DCDN may join the DCDN, and thereby become a member of one or more of the Virtual Halls in the DCDN, depending on eligibility and/or context. Membership may be short term or long term.

Proof of eligibility for membership in a DCDN is provided by way of a Virtual Insignia sent from a computing device to a DCDN system. A Virtual Insignia may be provided by way of a trigger. The trigger may be initiated by a user of the computing device, for example, at a user interface; however, the trigger may be initiated automatically, or may be initiated from another computing device. A Virtual Insignia may be associated with a Virtual Hall identifier, such that upon receipt of a form of the Virtual Insignia by the DCDN system, the associated Virtual hall identifier is identified.

A Virtual Hall contains information that is available to members of the Virtual Hall. Information may be transferred to a member from storage related to a Virtual Hall or the associated DCDN, or may be transferred between members of a Virtual Hall in a peer-to-peer (P2P) fashion. Information is transferred in either case by way of a data channel dedicated to the Virtual Hall, or a data channel dedicated to the DCDN. The data channel is accessed by a member of the Virtual Hall via an available communication interface on the computing device, such as via a 3G or 4G communication interface, or other wireless or wired interface. Thus, it is not necessary for a computing device to have access to the Internet to have access to the data channel.

A member may edit, delete or add information in a Virtual Hall. When information in the Virtual Hall is modified (e.g., edited, deleted or added), the modified information is synchronized to the Virtual Hall and to members of the Virtual Hall.

Having described the concepts of this disclosure at an overview level, an analogy to the physical world is next provided for a better understanding of the concepts.

An imaginary city, Montemar City, has a library system with a physical library location (the Montemar Library). Montemar Library contains several objects, including books, movies, music, and periodicals. Montemar Library also includes a climate-controlled room with artifact objects that require special credentials to access, as well as training with respect to how to handle such artifact objects without damaging them. Montemar Library defines three categories of access to the objects in the library: category A is defined as a public category including any person physically on the premises of Montemar Library; category B is defined as a resident category including any person that is a resident of Montemar City; and category C is defined as a researcher category including any person proving the appropriate credentials and proof of training to access the climate-controlled room with the artifact objects.

A person in category A gains access to the objects in the main part of the library (e.g., not in the climate controlled room) by virtue of a context of the person's presence in the library. A person who has obtained membership in category B (e.g., gotten a library card) gains access to the objects in the main part of the library by virtue of a context of the person's presence in the library, and is further is allowed to check out the objects in the main part of the library by virtue of the context of the person's library card. A person who has gained membership in category C (e.g., gotten researcher credentials and training verified, and consequently is provided a researcher card or code) gains access to the objects in the main part of the library by virtue of a context of presence of the person in the library, and is further is allowed to view and handle, but not check out, the objects in the climate controlled room by virtue of the context of the person's researcher card or code.

By analogy, the Montemar Library system may be analogized to a DCDN, and the definitions of categories A, B and C may be analogized to rules defined for membership in the DCDN, or rules defined for membership in Virtual Halls of the DCDN. In category A, the rules define a context for membership that is a presence in the physical space of the Montemar Library (e.g., at an address). In category B, the rules define a context for membership that is a residence within the boundaries of Montemar City (e.g., defined by a set of location coordinates on a map). In category C, the rules define a context for membership that is appropriate credentials and training (e.g., characteristics).

Extending the analogy further to an electronic version of the Montemar Library, a category A1 is defined as a public category including any person accessing a website of the Montemar Library; category B1 is defined as a resident category including any person that is a resident of Montemar; and category C1 is defined as a researcher category including any person proving the appropriate credentials and proof of training to access a particular set of objects. In this further analogy, a person in category A1 gains access to the objects in the main part of the website (e.g., not the particular set of objects) by virtue of the context of the person's computing device accessing the website. A person who has obtained membership in category B1 (e.g., gotten a library card) gains access to the objects in the main part of the website by virtue of the context of the person's computing device accessing the website, and is further is allowed to check out (e.g., download or email) the objects in the main part of the website by virtue of the context of the computing device providing library card information of the person. A person who has gained membership in category C1 (i.e., gotten researcher credentials and training verified, and consequently is provided a researcher card or code) gains access to the objects in the main part of the library by virtue of the context of the person's computing device accessing the website, and the person is further is allowed to view, but not check out, the particular set of objects by virtue of the computing device providing the researcher card or code of the person.

In the Montemar Library website analogy, the Montemar Library website may be analogized to a Virtual Hall with a main room and an extra content room (including the extra content of the particular set of objects), or may be analogized to two Virtual Halls (e.g., one for the main room of the Montemar Library and one for the extra content).

In the Montemar Library website analogy, the context is provided by way of a Virtual Insignia requesting access to a Virtual Hall. In category A1, the Virtual Insignia may be a null, meaning that no Virtual Insignia is required. In category B1 or C1, the Virtual Insignia may be an electronic library card or code that is selected manually or automatically on a computing device. Further in category C1, rules of the Montemar Library website may include that the extra content is only available when the computing device is on the premises of a physical location of the Montemar Library, in which case the Virtual Insignia may include the electronic library card or code, and additionally an indication that the computing device is on the premises of a physical location of the Montemar Library, such as a Wi-Fi device identifier, a group of Wi-Fi device identifiers, a prioritized list of Wi-Fi device identifiers, a set of location coordinates, a list of signal strengths of communication towers, an identifier in the library as read by a sensor, and so forth.

In the Montemar Library website analogy, a virtual geo-space (VGS) is defined by membership eligibility as related to a context. For example, consider that categories A1, B1 and C1 relate to respective Virtual Halls A1, B1 and C1. A VGS of Virtual Hall A1 includes a null context of all space (e.g., anywhere from which the Montemar Library website may be accessed); a VGS of Virtual Hall B1 includes a geographic context related to the space within the boundary lines of Montemar City (but note that the VGS expands to include member computing devices outside the boundary lines of Montemar City if under the control of a resident of Montemar City); a VGS of Virtual Hall C1 includes the present location of each member computing device of Virtual Hall C1 according to a characteristics context (e.g., appropriate credentials and training, independent of residence). In another example, a VGS of a Virtual Hall including categories A1, B1 and C1 would correspondingly include a combination of the associated VGSs of each of the previously-described Virtual Halls A1, B1 and C1. Note that a VGS of a Virtual Hall is defined by member devices; whereas a VGS of a DCDN is defined by member-eligible devices.

Having described the concepts of this disclosure in overview, and having provided analogies to better understand the concepts, next is provided detail of the concepts, along with examples.

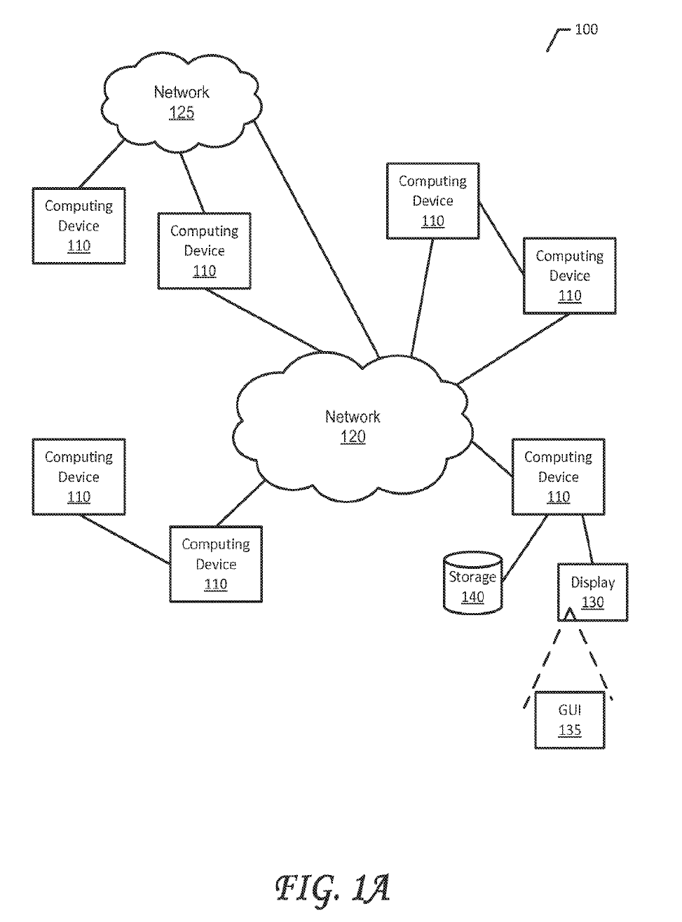

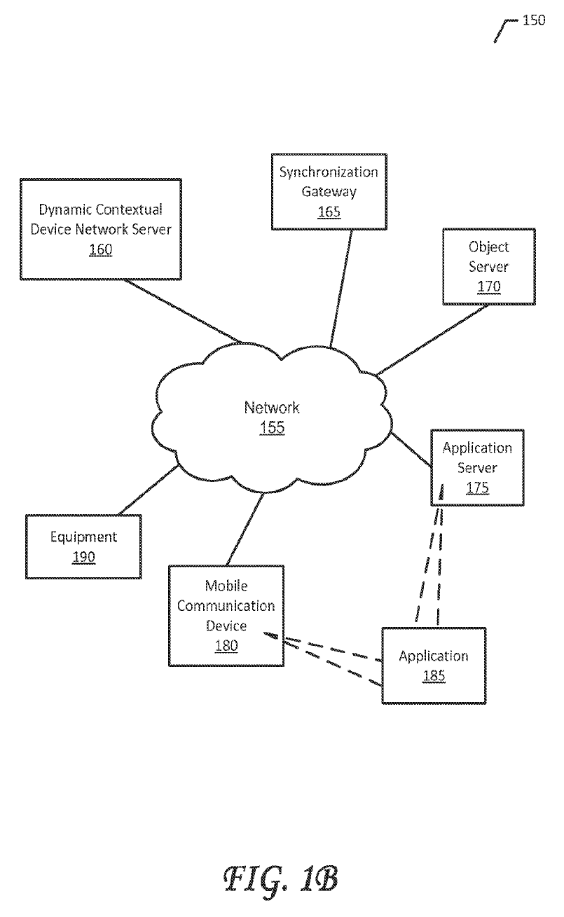

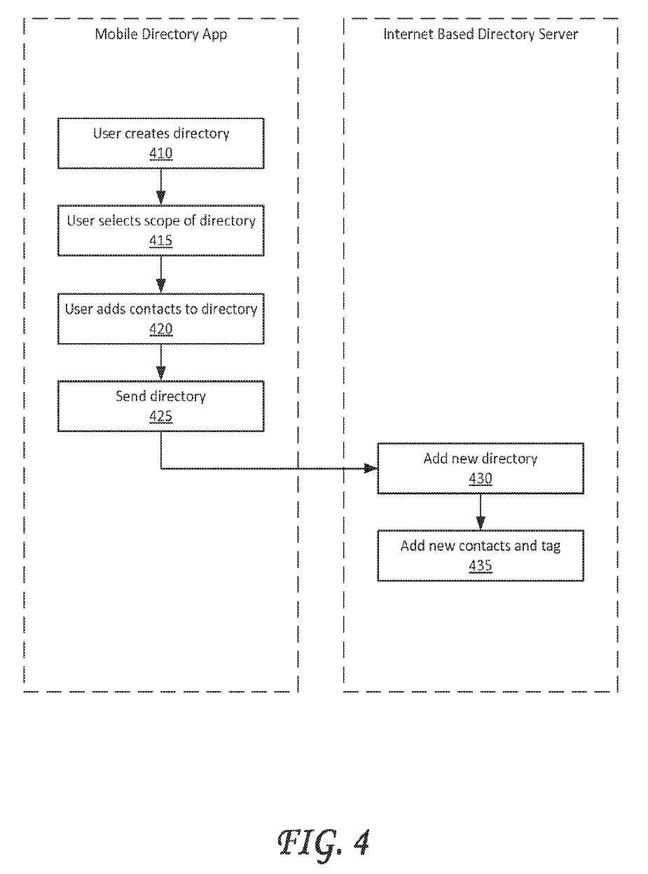

FIG. 1A is a representation of an example of a network environment 100 including multiple computing devices 110 in communication with each other over one or more networks 120, 125. As illustrated, computing devices 110 may communicate with each other directly, through another computing device 110, through one network 120 or 125, or through a combination of networks 120, 125. Computing devices 110 are devices including a combination of hardware and software (including firmware and hard-wired software), in which processing circuitry such as a processing device executes instructions that direct the processing circuitry to perform defined functions. Computing devices 110 are described in more detail with respect to FIG. 4.

Networks 120, 125 each represent one or more public or private networks. For example, one of networks 120, 125 may represent a local area network (LAN), a home network in communication with a LAN, a LAN in communication with a wide area network (WAN) such as the Internet, a WAN, or other networks, or a combination of networks. Portions of one or more network may be wired, and portions of one or more network may be wireless. Further, networks 120, 125 may include one or more of telephone networks, cellular networks, or broadband networks. Communication through the networks may be made using standard or proprietary protocols useful for the associated network. Although certain types or protocols of networks are described for particular embodiments in this disclosure, such types or protocols are not limiting unless so described, and it is to be understood that the concepts of this disclosure are generally applicable to a wide variety of network environments 100.

One or more computing devices 110 in the network environment 100 include a display 130 for providing information to a user of the computing device, and a graphical user interface 135 for interaction with the user. Input devices (not shown) allow the user to input information for the user interaction. In one or more embodiments, display 130 is a touch screen display, and is correspondingly also an input device. Other non-limiting examples of input devices include a mouse, a microphone, a camera, and a biometric detector.

One or more computing devices 110 in the network environment 100 include an external storage 140, which represents one or more memory devices for storing information. Storage 140, for example, is mass storage, and may include one or more databases. Storage 140 may be dedicated to one or more computing devices 110 (which may be co-located with storage 140 or in communication with storage 140 over one or more networks 120, 125), or may be non-dedicated and accessible to one or more computing devices 110 (locally or by way of one or more networks 120, 125).

As will be appreciated from the following discussions, FIG. 1A is provided by way of introductory overview illustrative of network environments generally. FIG. 1B provides a more specific embodiment of a network environment.

FIG. 1B is a representation of an example of a network environment 150 including multiple computing devices 160, 165, 170, 175, 180, 190 in communication with each other over a network 155. Computing devices 160, 165, 170, 175, 180, 190 are instances of computing devices 110 (FIG. 1A) configured for particular functionality. A portion of, or all of, computing device 160 is configured as a dynamic contextual device network server (herein, DCDNS 160); a portion of, or all of, computing device 165 is configured as a synchronization gateway 165 (herein, synch gateway 165); a portion of, or all of, computing device 170 is configured as an object server (herein, object server 170); a portion of, or all of, computing device 175 is configured as an application server (herein, application server 175); computing device 180 is a mobile communication device (herein, mobile device 180) such as smart phone, tablet, personal digital assistant, laptop, or other mobile computer; and computing device 190 is a piece of equipment (herein, equipment 190) such as a printer, a 3D printer, a scanner, a projector, a coffee machine, a video display, a television, a telephone, a light switch, a payment machine, a sound system, a security lock, a manufacturing equipment, a robot, or other equipment. DCDNS 160, synch gateway 165, object server 170 and application server 175 may be implemented on four separate computing devices, or on fewer devices. For example: DCDNS 160 and synch gateway 165 may implemented within one computing device 110; object server 170 and application server 175 may be implemented within one computing device; DCDNS 160, synch gateway 165, object server 170 and application server 175 may be implemented within one computing device; and so forth. Further, functionality of DCDNS 160, synch gateway 165, object server 170 and application server 175 may distributed over more than four computing devices. Thus, the illustration in FIG. 1B is representative of the functionality of the network environment 150 and not necessarily a specific physical implementation. Network 155 represents one more networks such as described with respect to networks 120, 125 (FIG. 1A).

Synch gateway 165 synchronizes information between computing devices within the network environment 150, such as synchronizing information between mobile devices 180, synchronizing information between a mobile device 180 and one or more of DCDNS 160, object server 170 and application server 175, or synchronizing information between two or more of DCDNS 160, object server 170 and application server 175.

Object server 170 stores and updates object information. For example, object information includes information related to mobile devices (such as mobile device 180) and equipment (such as equipments 190), as well as information related to DCDNs. Examples of objects are provided in the descriptions of various embodiments below.

Application server 175 stores and updates application information. For example, application information includes downloadable software modules. Examples of applications are provided in the descriptions of various embodiments below.

Network environment 150 may include an application 185 on a computing device, such as mobile device 180 or application server 175. In one or more embodiments, application 185 may be on an application server 175 that is part of mobile operator's network or management system; in other embodiments, application 185 may be a module that belongs to a service provider. Further, the functionality of application 185 may be split between two or more entities, such as split between application server 175 and mobile device 180. In one or more embodiments, application 185 can manage, create, or discover DCDNs. A DCDN typically includes two or more mobile devices 180; however, there may be times when a DCDN includes just one mobile device 180.

As can be seen from the analogies given above, context may or may not be related to location. When context is related to location, determination of present location may be a challenge, especially when in a three-dimensional location, such as in a multi-story building. Some of the challenges faced are that location services are generally kept disabled on a computing devices due to energy consumption, many location services do not work indoors, and location services such as global positioning system (GPS) use two-dimensional (not three-dimensional) location data. Further, a GPS location search is a slow and battery-consuming process. Additionally, Wi-Fi devices do not offer location coordinates, near-field communication sensors are not in widespread use and span very short distances, and triangulation may not be sufficiently accurate. Instead of determining a present location of a computing device (e.g., using GPS, triangulation, or other location technique) to establish location context, the techniques of one or more embodiments of this disclosure alternatively or additionally provide a location context of the computing device separate from present location, as will be described below.

As described above, a VGS may be defined by the rules of the DCDN in terms of geographic coordinates, such as having a perimeter based on map coordinates; however, a VGS is not limited to such map coordinates, and may instead be a virtual space additionally or alternatively defined by characteristics. Thus, although a VGS may include geographic locations (e.g., mobile devices 180 of a DCDN are located in a VGS spanning different cities, states, countries, or continents), a VGS is not necessarily defined by geographic locations.

A VGS may be three-dimensional (3D) in one or more embodiments, such as spanning a geographic area of multiple floors in a multi-story building at a specific address. Other examples of 3D VGSs include the locations of an aircraft (or spacecraft) and its associated ground control (both of which may change over time), and an interplanetary VGS. A VGS may have a fuzzy perimeter, meaning that the perimeter is not clearly defined in terms of any geographic coordinate system. Further, a VGS perimeter (in terms of a geographic coordinate system) may be dynamic.

In embodiments for which there is a defined or partially defined perimeter (which may be fuzzy), such as a company with offices on several floors of one building, or offices on one floor of several buildings, the perimeter may be defined by a postal address or geographic coordinates, or may be defined by signals present within the perimeter and available at the perimeter. For example, one or more transmitting devices may emit signals at specific predefined frequencies and/or using specific messages or coding; the reception area of the signal(s) defines the VGS perimeter. Note that the perimeter in this example is fuzzy, in that different receiving devices (e.g., mobile device 180) have different sensitivities, and the reception area for one receiving device may be different than the reception area for another receiving device. The perimeter in this example is also fuzzy in that the transmitting device(s) may have varying emission levels, or there may be electrical interference that reduces the reception area for some receiving devices. Non-limiting examples of transmitting devices include unidirectional radio frequency (RF) emitters, Wi-Fi devices and infrared devices.

In one or more embodiments, a VGS defines a pseudo-geographic space where a computing device 110 (FIG. 1A) of a specific DCDN is permitted to be present. For example, a company DCDN may define a VGS that includes the company's residence (i.e., address(es)), as well as the company's employees' residences and vehicles, and if a specific mobile device 180 of the DCDN leaves the pseudo-geographic space of the VGS, a notification is made to the company.

In one or more embodiments, for a VGS with or without a defined perimeter, an associated DCDN may use device identifiers (IDs) to define devices that are to be allowed into, or are to be excluded from, the DCDN.

As described above, in one or more embodiments, a VGS is geographically agnostic. A geographically agnostic VGS may be defined by common characteristics of one or more mobile devices 180, or common characteristics of users of the mobile devices 180.

A VGS may be static, such as defined by an address, or semi-static, such as defined by one or more transmitting devices emitting a signal. A VGS may be dynamic, in that, as a mobile device 180 is added to (or removed from) a DCDN, an associated VGS may expand (contract) to include (exclude) a geographic location or other context related to the mobile device 180, as applicable. In one or more embodiments, a VGS may be static at times, semi-static at times, or dynamic at times. For example, a non-geographic VGS of a mobile library DCDN may be static during a time that an associated carrier vehicle is in transit and the DCDN includes the mobile devices 180 on board the vehicle, and then become dynamic when parked at a location with materials being checked out (e.g., a user desires to check out a book and therefore joins the DCDN, and the VGS dynamically expands to include a context of the user or the user's mobile device 180). For another example, a VGS may be static while a vehicle associated with the DCDN is parked in a home garage, but becomes dynamic as the vehicle moves along the streets and adds/subtracts nearby vehicles to/from the DCDN based on location or context (e.g., context such as “moving” or “not moving”).

In one or more embodiments, a VGS may be defined in the DCDN by one of, or a combination of, Wi-Fi device information, GPS position, or triangulation information. For example, location for a VGS may be related to one or more Wi-Fi media access control (MAC) identifiers (IDs), one or more mobile communication tower IDs, one or both of GPS position or triangulation information, or a combination thereof. In embodiments in which MAC IDs are used as location information for a VGS, if a Wi-Fi device associated with a MAC ID is mobile, the VGS will have a dynamic boundary.

The use of Wi-Fi signals to mark the boundary of a VGS may be convenient, as Wi-Fi sources are prevalent, and appropriate in terms of range, size and availability. Notably, however, although Wi-Fi signals may be used to identify the boundary of a VGS, in one or more embodiments, the Wi-Fi network itself is not used for communication within the DCDN.

As described with respect to the Montemar Library analogy above, a DCDN may define one or more VGS. For another example, a DCDN may include any computing device associated with a user that graduated from Santa Clara University, and the associated VGS encompasses all such devices based on the context of graduation from Santa Clara University. However, the DCDN may be sub-divided by graduation year, so the context information of graduation year further defines one VGS for each graduation year in addition to the larger VGS related to the context information of Santa Clara University. Information related to defining a VGS may be copied from one DCDN to another DCDN.

As introduced by the examples above, a DCDN (and its associated VGS) is defined by a set of rules related to context. Non-limiting examples of context include context related to a mobile device 180, such as location, available networks, present status (e.g., moving or not moving), capability, model name or number, device ID, or settings (e.g., an indicator that it is a child's device, a “do not contact” setting, or a low battery lockout). Non-limiting examples of context include context related to a user of a mobile device 180, such as demographic information (e.g., birth year, city of residence, employer, degrees earned, school graduated from, and medical information), frequency of presence in a geographic area, interests, present activity and memberships. A DCDN may be established as short term (e.g., hours, minutes, seconds, or shorter) or long-term (days, weeks, months, years, or longer).

Thus, a DCDN as defined may encompass a narrow or a wide variety of permitted users or mobile devices 180. By way of a few non-limiting examples, a DCDN may encompass: some or all of the mobile devices 180 present in a conference room; some or all of the mobile devices 180 that will be present in a conference room any time in the next year; some or all of the mobile devices 180 that will be present in a conference room any time in the next year along with all of the other computing devices 110 presently in the conference room; some or all of the mobile devices 180 associated to members of a core family unit; some or all of the mobile devices 180 associated to members of an extended family; and some or all of the mobile devices 180 along with all of the other computing devices 110 at a residence. More examples are provided in the discussions below.

The DCDN defines eligibility for membership, which also defines the VGS. It is possible that all eligible mobile devices 180 (or mobile devices 180 associated with eligible users) may not join the DCDN, or may be excluded from the DCDN. The mobile devices 180 that successfully join the DCDN become members of a Virtual Hall of joined mobile devices 180 in the DCDN. A Virtual Hall may further include one or more equipments 190, as will be seen in the examples below. Information regarding eligible or joined members may be copied from one Virtual Hall to another. Members of a Virtual Hall may exchange information with each other over a data channel assigned to the Virtual Hall (or a data channel assigned to the associated DCDN). Access to the data channel is provided to member devices.

Referring still to FIG. 1B, application 185 may receive a request from a requesting mobile device 180 to join a DCDN (and thereby become a member of a Virtual Hall in the DCDN). In one or more embodiments, a request may be made by submission of a Virtual Insignia, as described below. If the request is approved (e.g., the mobile device 180 or associated user meets the rules defining the DCDN and is not excluded), the mobile device 180 is tagged by application 185 or by DCDNS 160 as a member of the Virtual Hall. For example, a tag may be a key provided to the mobile device 180, or an entry in a data store (e.g., in storage 140 in FIG. 1A, or in a memory of DCDNS 160, synch gateway 165, object server 170, or application server 175). Once a member, mobile device 180 is then provided access to information available in the Virtual Hall, and is also provided access to modify information within the Virtual Hall. Synch gateway 165 provides a download of information available in the Virtual Hall to the mobile device 180 and may provide information related to the mobile device 180 to other members in the Virtual Hall. In general, modifications to information in the Virtual Hall are synchronized by synch gateway 165 to each of the members of the Virtual Hall, which now include the new member mobile device 180.

In addition to members of the Virtual Hall including mobile devices 180, members of a Virtual Hall may include one or more equipments 190, as will become apparent from the examples below. Thus, the term “member device” as used going forward applies to both mobile devices 180 and equipments 190 that are members of a Virtual Hall.

Information may be synchronized directly between member devices of the Virtual Hall, such as through a P2P protocol. Additionally or alternatively, information may be synchronized between member devices of the Virtual Hall by adding information to one or more of the DCDNS 160, object server 170, or application server 175 from a member device, then synchronizing other member devices with the added information.

A DCDN is, at an overview level, a virtual directory of information. Objects (e.g., objects stored at object server 170) in the DCDN contain information such as, for example, a notice board, a bookmark for a website, a menu, a form of media content (e.g., a document, a video, a picture, a sound file, a scent file, a Braille or other touch device file, etc.), a comment book, and a virtual registration desk. Many other objects may additionally or alternatively be implemented for a particular DCDN, and different objects may be included within different DCDNs. Objects may be copied between DCDNs, or between Virtual Halls. Different object servers 170 may host collaboration objects like a chat, a video conference, a whiteboard, an announcement, an update, a queue, ticketing, a contact exchange, and so forth.

As described above, in one or more embodiments, a VGS of a Virtual Hall may be defined by context information of permanent members of the Virtual Hall, rather than by location information. In this way, there may be rapid information exchange without having to define region boundaries, and without turning on a GPS locator. For example, the VGS of a Book Club Virtual Hall may be defined by the contextual information of “book” and “mystery” along with device or user IDs for each of the permanent members, agnostic of location. In one or more embodiments, if a computing device or user associated with contextual information including “book” and “mystery” is later identified, that computing device or user may be invited to become a member of the Virtual Hall, or may be automatically included as a member of the Virtual Hall, regardless of location. In other embodiments, if a computing device associated with contextual information including “book” and “mystery” is identified in proximity to an existing member of the Virtual Hall, that computing device may be invited to become a member of the Virtual Hall, or may be automatically included as a member of the Virtual Hall.

It should be noted that in one or more embodiments, different members may have different rights to access the information of a Virtual Hall.

In one or more embodiments, a Virtual Hall in a DCDN with a location-based VGS may remain open to a member even when the member leaves the VGS, as the VGS represents rules of eligibility for membership, but those rules need not symmetrically terminate membership. For example, once a computing device (or associated user) has met the rules for becoming a member of a company-based DCDN, the computing device may remain a member after hours or while the computing device is traveling. For another example, with respect to the “book” and “mystery” contextual identifiers of the book club Virtual Hall described above, if a user deletes “book” and adds “movie,” or deletes “mystery” and adds “suspense,” the user or computing device may still remain a member of the book club Virtual Hall, depending on the rules for the DCDN. It should be noted as a reminder here that, although a user may be referred to as a member of a Virtual Hall, such a reference is shorthand notation indicating that the user meets the rules for the DCDN, and a device associated with the user has successfully become a member of a Virtual Hall.

Virtual Halls may be combined to create larger Virtual Halls, or divided to create smaller Virtual halls. In one or more embodiments, a Virtual Hall may have separate areas or rooms with limited access to information, where a member device is provided access to the separate areas or rooms based on the member device's security level, identity, associated user identity, or associated user preferences. Thus, in one or more embodiments, the information available to a member device in a Virtual Hall is customized based on member's security level, identity, associated user identity, or associated user preferences.

When geographic location is part of the VGS of a DCDN, application 185 may determine the location of a Virtual Hall member device (e.g., a mobile device 180 or an equipment 190) or a DCDN membership-eligible device. For example, application 185 may trigger a member device or member-eligible device to activate its GPS chip, obtain GPS location data, and provide the GPS location data to application 185. As a member device moves around, its location information is updated to application 185 and synchronized with other member devices. Mechanisms for determining if a member device is moving include, but are not limited to, the use of an accelerometer to detect stepping motion, a radio signal strength sensor to detect increasing or decreasing signal strength, triangulation between geo-locators or cellular towers, beacons, or GPS signal detection.

As a mobile device 180 (and in one or more embodiments, an equipment 190) move around, DCDNS 160 identifies DCDNs for which the mobile device 180 (or equipment 190) is membership-eligible, either through context of the mobile device 180 (or equipment 190), or through context of a user of the mobile device 180 (or equipment 190). DCDNS 160 provides a list of the available DCDNs for which the mobile device 180 (or equipment 190) is eligible, and the mobile device 180 (or equipment 190) elects whether or not to join an available DCDN (e.g., through user preference settings), or a user associated with mobile device 180 (or equipment 190) elects whether or not to join an available DCDN.

In one or more embodiments, a mobile device 180 (or equipment 190) may be tagged when the rules of a DCDN are met, and untagged when the rules of the DCDN are no longer met. For example, as a mobile device 180 moves within a perimeter of a geographic location-based VGS, it may be tagged as member-eligible; and when the mobile device 180 moves outside the perimeter of the geographic location-based VGS, it may be tagged as being member-ineligible or untagged as being member-eligible. For another example, upon graduation of a user from a particular Example University, each of the associated user's mobile devices 180 may be tagged as member-eligible of a DCDN for new graduates of the Example University; however, after two years, the user is no longer a new graduate according to the context rules of the DCDN, and each of the user's mobile devices 180 is therefore tagged as member-ineligible for that DCDN.

New DCDNs may be created via a mobile device 180 (or equipment 190), as will be described below.

Virtual Insignias were introduced briefly above. A Virtual Insignia may be defined for a DCDN or for a Virtual Hall. Examples of Virtual Insignias include predefined symbols, such as a bar code, a quick response (QR) code, an icon, a picture, a photograph, a video, a sound, a smell, a biometric input (e.g., a fingerprint, an eye scan, a chemical profile, a heartbeat profile, a DNA profile or a voiceprint, such as for accessing a personal Virtual Hall), a phone number, another number, other Virtual Insignia, or a combination thereof. Such a symbol is read by a reading device of the computing device or a reading device coupled to the computing device, and converted to a form useful for transmission to a DCDNS. Examples of Virtual Insignias further include electronic indicators, such as a website link, an invitation, a short message service (SMS) message or a text message, where a selection of the electronic indicator may initiate entry to a DCDN or Virtual Hall (e.g., by selecting a website link, opening a message or replying to a message). Examples of Virtual Insignias further include signal signatures, such as MAC IDs, a prioritized list of MAC IDs based on signal strength or user preference, a list of communication tower IDs, a prioritized list of communication tower IDs, an infrared device ID, an RF device ID, other signal signature, or a combination thereof. A signal signature is sensed by the computing device in its present environment, and converted to a form useful for transmission to a DCDNS.

Where a combination of symbols or a combination of signal signatures is used for the Virtual Insignia, the computing device may combine the information of the multiple symbols or signal signatures prior to sending the combined information to the DCDNS; however, the computing device may send information related to the individual symbols or signal signatures separately.

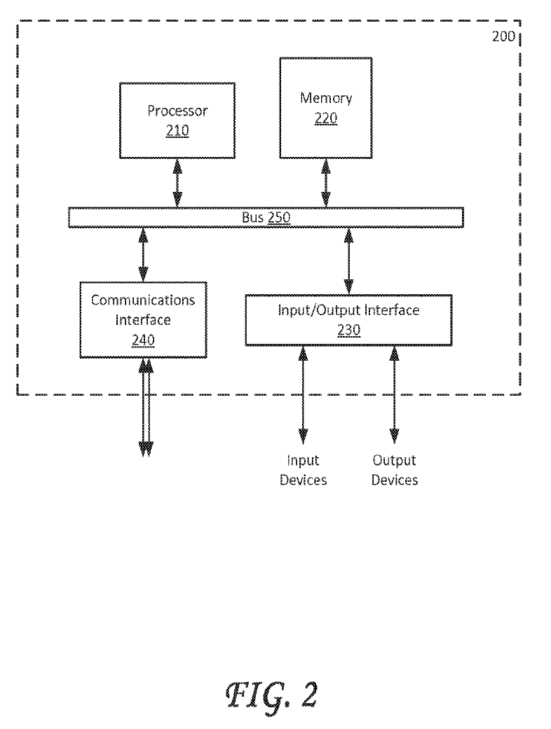

A Virtual Insignia may be defined for use to initially request membership in a DCDN or a Virtual Hall. Alternatively, a Virtual Insignia may be defined for use by members of a Virtual Hall. As discussed above, DCNS 160, synch gateway 165, object server 170, application server 175, mobile device 180 and equipment 190 are all examples of computing devices 110, or are implemented in one or more computing devices 110. Computing devices are described in general with respect to FIG. 2.

FIG. 2 illustrates an example of a computing device 200 that includes a processor 210, a memory 220, an input/output interface 230, and a communication interface 240. A bus 250 provides a communication path between two or more of the components of computing device 200. The components shown are provided by way of illustration and are not limiting. Computing device 200 may have additional or fewer components, or multiple of the same component.

Processor 210 represents one or more of a processor, microprocessor, microcontroller, application-specific integrated circuits (ASIC), and/or field-programmable gate array (FPGA), along with associated logic.

Memory 220 represents one or both of volatile and non-volatile memory for storing information. Examples of memory include semiconductor memory devices such as EPROM, EEPROM, RAM, and flash memory devices, discs such as internal hard drives, removable hard drives, magneto-optical, CD, DVD, and Blu-ray discs, memory sticks, and the like.

Portions of the network environment 150 of this disclosure (e.g., portions of, or all of, DCDNS 160, synch gateway 165, object server 170 and application server 175, as well as mobile device 180, equipment 190 and application 185) may be implemented as computer-readable instructions in memory 220 of computing device 200, executed by processor 210.

Input/output interface 230 represents electrical components and optional code that together provides an interface from the internal components of computing device 200 to external components. Examples include a driver integrated circuit with associated programming.

Communication interface 240 represents electrical components and optional code that together provides an interface from the internal components of computing device 200 to external networks, such as network 120 or network 125 (FIG. 1A) or network 155 (FIG. 1B).

Bus 250 represents one or more interfaces between components within computing device 200. For example, bus 250 may include a dedicated connection between processor 210 and memory 220 as well as a shared connection between processor 210 and multiple other components of computing device 200.

An embodiment of the disclosure relates to a non-transitory computer-readable storage medium having computer code thereon for performing various computer-implemented operations. The term “computer-readable storage medium” is used to include any medium that is capable of storing or encoding a sequence of instructions or computer codes for performing the operations, methodologies, and techniques described herein. The media and computer code may be those specially designed and constructed for the purposes of the embodiments of the disclosure, or they may be of the kind well known and available to those having skill in the computer software arts. Examples of computer-readable storage media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as ASICs, programmable logic devices (PLDs), and ROM and RAM devices.

Examples of computer code include machine code, such as produced by a compiler, and files containing higher-level code that are executed by a computer using an interpreter or a compiler. For example, an embodiment of the disclosure may be implemented using Java, C++, or other object-oriented programming language and development tools. Additional examples of computer code include encrypted code and compressed code. Moreover, an embodiment of the disclosure may be downloaded as a computer program product, which may be transferred from a remote computer (e.g., a server computer) to a requesting computer (e.g., a client computer or a different server computer) via a transmission channel. Another embodiment of the disclosure may be implemented in hardwired circuitry in place of, or in combination with, machine-executable software instructions.

Having described generally a network environment 100 and more specifically a network environment 150, next are described various embodiments in accordance with this disclosure.

Environment A

Present techniques for gaining access to area contact information is tedious, especially, for example, when the user's device is temporarily not connected to the Internet. Getting local contact information generally requires searching or requesting contact information from other people or from the Internet. Further, because area contacts are relevant to the area and not just a particular geographic coordinate, identifying the relevant area in which to search is also a challenge. Environment A allows for a user friendly and efficient way to discover contact information autonomously based on location area of the device, as well as a way for such contacts as a group to appear in the mobile devices discreetly and securely even when the device goes offline.

In one or more embodiments, the concepts of this disclosure are useful, for example, when a user arrives within some boundary (e.g., an airport, a certain number of miles from a city center, or an area of a city) which is defined as a VGS of a DCDN. Rules of a DCDN may define a VGS according to the boundary, such as all locations having a certain zip code, all locations within four-corner map coordinates, all locations within a radius of ten miles of the city center, and so forth. Upon entering the VGS, a Virtual Insignia is sent to the DCDNS, which responds by providing a list of available DCDNs, or responds by automatically granting access to a Virtual Hall in an available DCDN. Such Virtual Hall includes a directory of relevant area contacts, where “relevant” is as defined by the person by way of user settings, defined by the DCDNS 160, or defined by persons in the area, for example. The relevant contacts of the Virtual Hall may be automatically loaded into a Virtual Hall directory in a phone directory application on the user's computing device. The Virtual Hall directory may then be erased from the person's computing device when the computing device leaves the boundary (alternatively, an opportunity to erase the Virtual Hall directory is provided when the person's computing device leaves the boundary). Membership in the Virtual Hall may, but does not necessarily, expire when the computing device leaves the boundary.

In another example, contacts may be bound to a local office Wi-Fi (e.g., defining a VGS of a local office Virtual Hall); when the user's computing device senses a particular Wi-Fi fingerprint (a Virtual Insignia of the local office Virtual Hall), the public facing contacts and other information (e.g., members and objects of the Virtual Hall) will become available on the user's computing device.

In one or more embodiments of Environment A, a Virtual Hall directory includes emergency contact information or company contacts and websites. In one or more embodiments, a Virtual Hall directory provides for the creation of a local mobile-based private automatic branch exchange (PABX) or messaging system dynamically.

The user may make changes to the contacts in a Virtual Hall directory, and the changes are then synchronized with the database and with directories in the computing devices of other users. For example, the user may provide a rating for a company in a directory, which is then synchronized across instances of the directory.

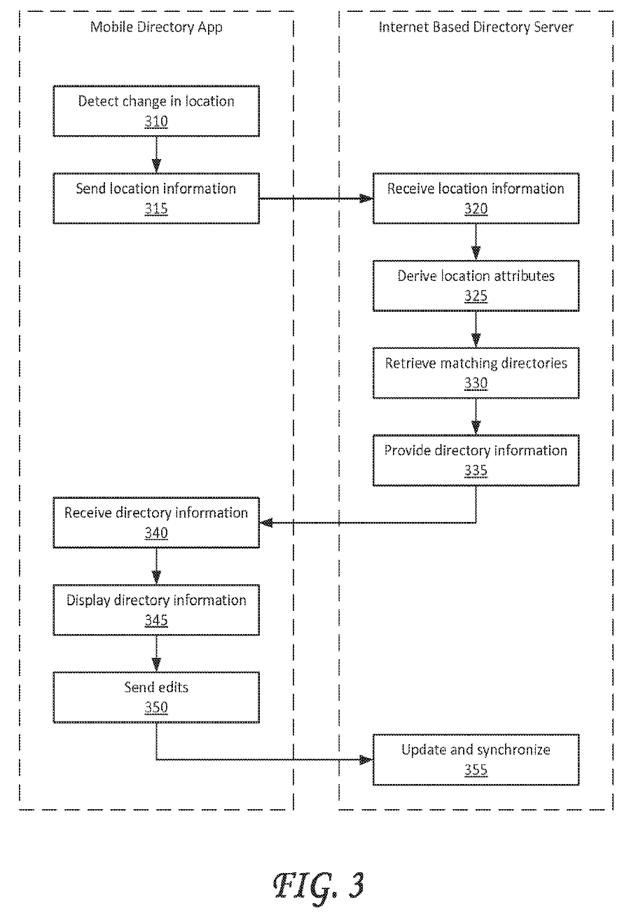

FIG. 3 provides further detail of Environment A by way of a flow diagram, which is shown as activity within and between a directory application (“Mobile Directory App”) and a directory server (“Internet Based Directory Server,” or IDS).

When the Mobile Directory App detects (at 310) that there has been a change in location, such as by a change in GPS coordinates or a change identified using triangulation techniques, the new location (i.e., a Virtual Insignia) is sent (at 315) to the IDS. Alternatively, the Mobile Directory App detects (at 310) that there has been a change in the Wi-Fi fingerprint (e.g., number of Wi-Fi signals, strengths of Wi-Fi signals, Wi-Fi IDs, or relative strength of Wi-Fi signals from different Wi-Fi sources), and a new Wi-Fi fingerprint (i.e., a Virtual Insignia) is sent (at 315) to the IDS. In one or more embodiments, instead of Wi-Fi fingerprints, other signal signatures may be used.

The IDS receives (at 320) the location or signal information, and derives (at 325) additional location attributes, such as available public Wi-Fi networks, address, suburb, city, state, province, country, continent, and so forth.

The IDS retrieves (at 330) directories or contact groups (e.g., Virtual Halls) associated with the location. The IDS may store contacts along with group tags, where the group tags are associated with the location. The IDS may store directories including location attributes associated with the location. In one or more embodiments, a directory may be associated with a local Wi-Fi hotspot. Location attributes are matched with stored locations to find relevant directories (e.g., Virtual Halls), and tags are used to retrieve contacts associated with the directories. The IDS sends (at 335) the retrieved contacts along with the directory name (e.g., Virtual Hall name) to the Mobile Directory App to synchronize the computing device.

The Mobile Directory App receives (at 340) the contact information (e.g., the local contacts sent by the IDS at 335) and makes available (at 345) the contact information for the user to view, add, edit or delete. If the user makes changes, the changes are sent (at 350) to the IDS, and the IDS synchronizes (at 355) itself, as well as directories in the computing devices of other users (i.e., other members of the Virtual Hall).

In one or more embodiments, the Mobile Directory App checks for location or signal signature change periodically, at the occurrence of an event, or upon user request. If such a change is detected, the technique described by FIG. 3 is initiated.

In one or more embodiments, when the Mobile Directory App sends (at 315) the new location to the IDS, the IDS identifies if there are directories (e.g., Virtual Halls) that are no longer relevant (e.g., not relevant to the new location), and removes irrelevant directories at the next synchronization (e.g., at 335 or 355).

Synchronization may be optimized to reduce network bandwidth consumption. Further, in one or more embodiments, information provided by the IDS (e.g., at 335 or 355) may omit geo-tagging information, thereby further reducing network bandwidth consumption.

FIG. 4 provides further detail of Environment A by way of a flow diagram, describing creating a location context-based directory.

A user creates (at 410) a new public directory (Virtual Hall) using the Mobile Directory App, and selects (at 415) location attributes to which to bind the directory, such as a particular Wi-Fi signal, a group of Wi-Fi signals, another type of signal(s), a GPS location, a GPS location with an associated radius, a neighborhood, a suburb, a city, and so forth.

The user adds (at 420) contact records to the directory. Alternatively, the addition of contact records may be done automatically by presence management filters. The Mobile Directory App provides (at 425) the directory and contact records to the IDS, which appends (at 430) the directory and location information to the directory server, and adds (435) the contact records and a directory tag (e.g., a Virtual Hall identifier) to the directory. The user may associate a symbol or other Virtual Insignia with the directory, such that the IDS associates a received version of the Virtual Insignia with the Virtual Hall identifier for the directory.

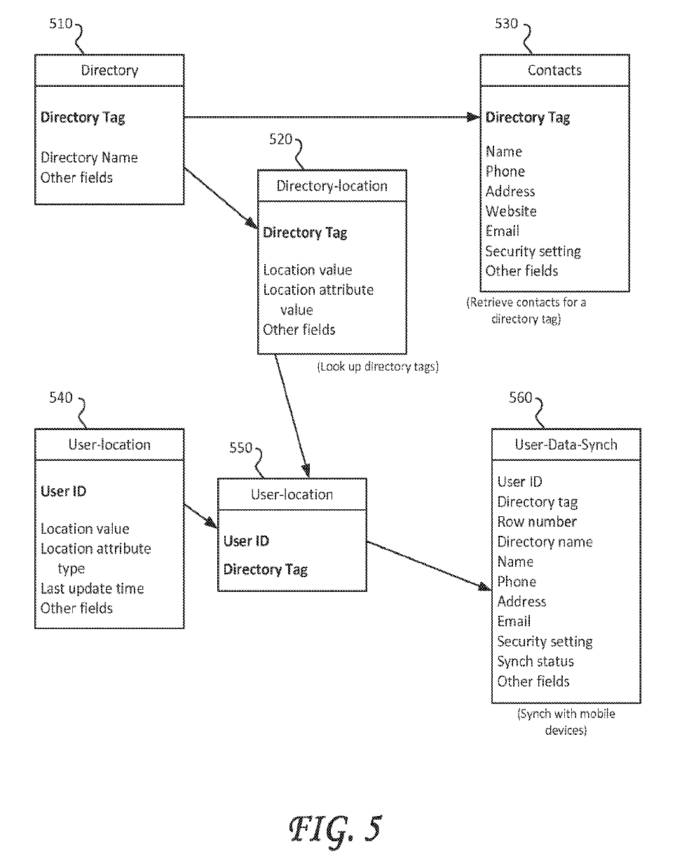

FIG. 5 provides further detail of Environment A by way of providing a table structure of the IDS, describing examples of tables in which directory and location information may be stored. The table structure is provided by way of non-limiting illustration as a structure in a relational database management system (RDBMS); however, other database systems may be used instead.

Table 510 contains a list of unique directories (Virtual Halls). Multiple locations can share one directory, or multiple directories may be applicable to one location. The Mobile Directory App may provide for local group messaging and calling; thus, a directory may be used, for example, for messaging, calling through VoIP or video conferencing (e.g., using a data channel of a Virtual Hall or DCDN). A directory may contain objects, data or links to objects that may be retrieved at a location through the Internet directory server. Such objects may be, for example, files, photos, location maps, website links or configuration files.

Table 520 contains associations of directories with different location attributes. Location attributes may include, but are not limited to, Wi-Fi ID, city, suburb or GPS location. A directory may include one or more location attributes, which may be changed, such as to increase or decrease a coverage area. Location attributes thus may be different than a location coordinate. Table 520 is used to find directories to be loaded onto a member computing device.

Table 530 contains contact records for the directories. The table may be normalized. Contact records may include entries such as name, organization, purpose, phone, email, or website. A contact record may have different format than shown in FIG. 5.

Table 540 contains descriptions of member computing devices with location attributes.

Table 550 contains directories that positively compare with a user's computing device location attributes.

Table 560 contains records to be synchronized with a member computing device.

Additional tables (not shown) may be used for additional features, such as for documenting security, users, and directory ownership.

In a variation of Environment A, an application may be provided that acts like a virtual electronic private automatic branch exchange (EPABX) system at a location. The virtual EPABX may automatically emerge by adding people based on their pattern of presence at the location having a common attribute or ‘Wi-Fi associated’ directory. For example, if a user's computing device is present at a location for ten hours a week over at least three days (e.g., as indicated by a signal signature history), location information for the user's computing device can be associated to a Wi-Fi device used at that location. The user's computing device and other users' computing devices that are also present at that location for more than ten hours a week over at least three days can be added as members of a Wi-Fi associated directory (Virtual Hall) for that location. Further, the Wi-Fi associated directory may be augmented based on matching the Wi-Fi associated directory location information with location information of contacts in other directories.

A computing device location may be detected by scanning periodically, to save energy. A history of scans may be maintained to assess approximate durations at a location, or to predict location from the history. Computing devices may be configured to scan at certain times or certain intervals, so to improve a probability that location information of computing devices in proximity to each other will be consistent (e.g., providing for better matching capability).

Environment B

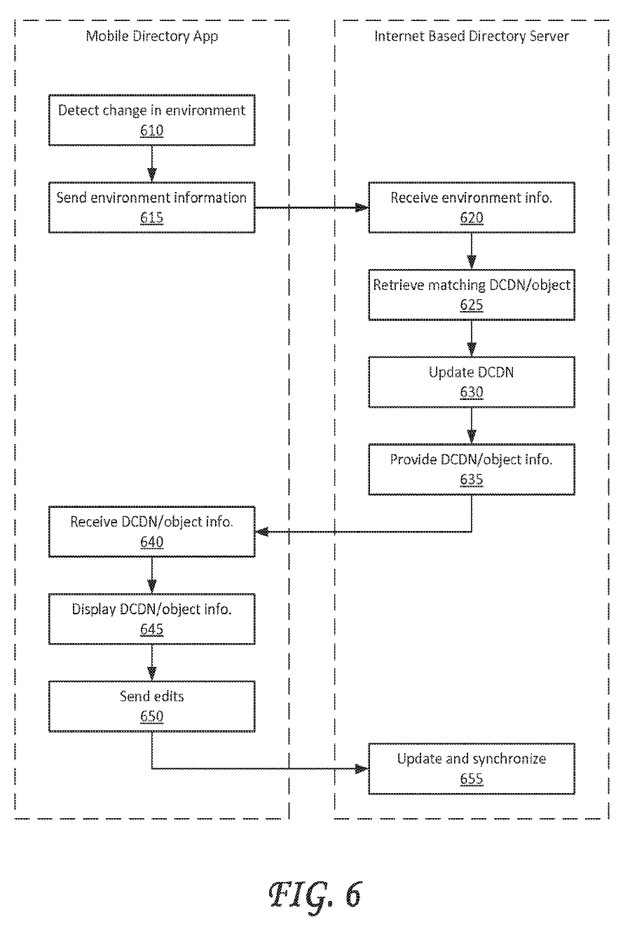

FIG. 6 provides detail of an Environment B by way of a flow diagram, describing communication between a computing device (e.g., mobile device 180 in FIG. 1B) and a DCDNS (e.g., DCDNS 160 in FIG. 1B). Referring to FIG. 1B and FIG. 6, when mobile device 180 enters a location, a Mobile Directory App on the mobile device 180 detects (at 610) a change in the environment of mobile device 180 (e.g., a change in signal signature, such as a change in MAC address, Wi-Fi fingerprint, radio signature of a wireless network, or a change in location), and sends (at 615) the new environment information to the DCDNS 160, which may be a cloud server in the Internet. DCDNS 160 receives (at 620) the environment information and searches (at 625) a database for matching environment information. Alternatively, DCDNS 160 may derive additional environment information (e.g., mobile device 180 specific information, or attributes which are specifically assigned to mobile device 180 such as Virtual Halls, directories, virtual rooms or other tagged information associated with the Mobile Directory App) and then search (at 625) the database for environment information matching the additional environment information. In one or more embodiments, DCDNS 160 alternatively or additionally receives (at 620) user attributes which are used to search (at 625) a database and find attributes such as preferences, user credentials, and security level. In any case, DCDNS 160 identifies a DCDN through the search (at 625). DCDNS 160 updates (at 630) the DCDN found in the search (at 625) with the environment information (e.g., mobile device 180 associated information such as a contextual network associated with mobile device 180 location information, contacts, contacts groups, preferences, or other user information). DCDNS 160 then marks mobile device 180 as a member of a Virtual Hall of the DCDN, and provides (at 635) Virtual Hall information to mobile device 180, and synchronizes the same with other mobile devices 180 that are members of the Virtual Hall.

Mobile device 180 receives (at 640) the Virtual Hall information from DCDNS 160, and the Mobile Directory App provides (at 645) some or all of the Virtual Hall information to a display. A user of mobile device 180 may edit the directories or information, and the Mobile Directory App synchronizes (at 650) such edits with DCDNS 160. In turn, DCDNS 160 synchronizes (at 655) the edits to other members of the Virtual Hall. In one or more embodiments, DCDNS 160 synchronizes (at 655) the edits to certain members of the Virtual Hall based on context.

In one or more embodiments, synchronization is optimized to reduce network bandwidth consumption. For example, in one or more embodiments, information synchronized (e.g., at 635, 655) is limited to relevant data or revised data.

DCDNS 160 may include a database of several DCDNs, each DCDN related to many users, computing devices, objects and other information. DCDNS 160 may include a table of location attributes associated with the DCDNs; the location attributes are matched with the database of DCDNs to identify relevant DCDNs, and the tags are used to retrieve the objects or data associated with those DCDNs.

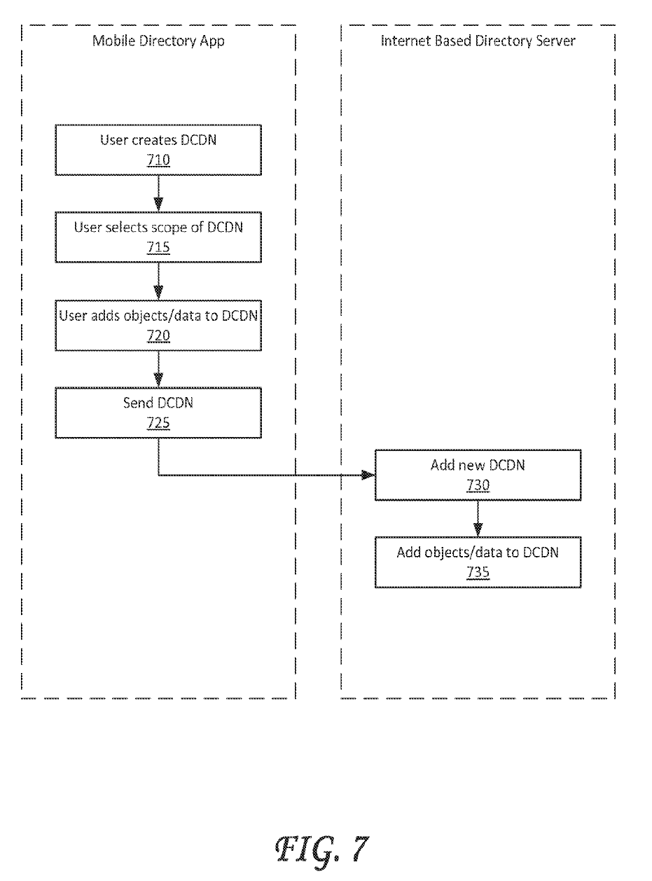

FIG. 7 provides further detail of Environment B by way of a flow diagram, describing creating a contextual network through a Mobile Directory App. A user creates (at 710) a new DCDN on mobile device 180. The user chooses (at 715) from a list of possible contextual attributes on which the DCDN is to be bound. The user adds (at 720) objects and information to the DCDN, which are the synchronized (at 725) by the Mobile Directory App to the DCDNS 160. The DCDN is added (at 730) with tags as a new DCDN to a DCDN database by DCDNS 160, and then the associated objects and data are added (at 735) to the new DCDN. The user may associate a symbol or other Virtual Insignia with the DCDN, such that.

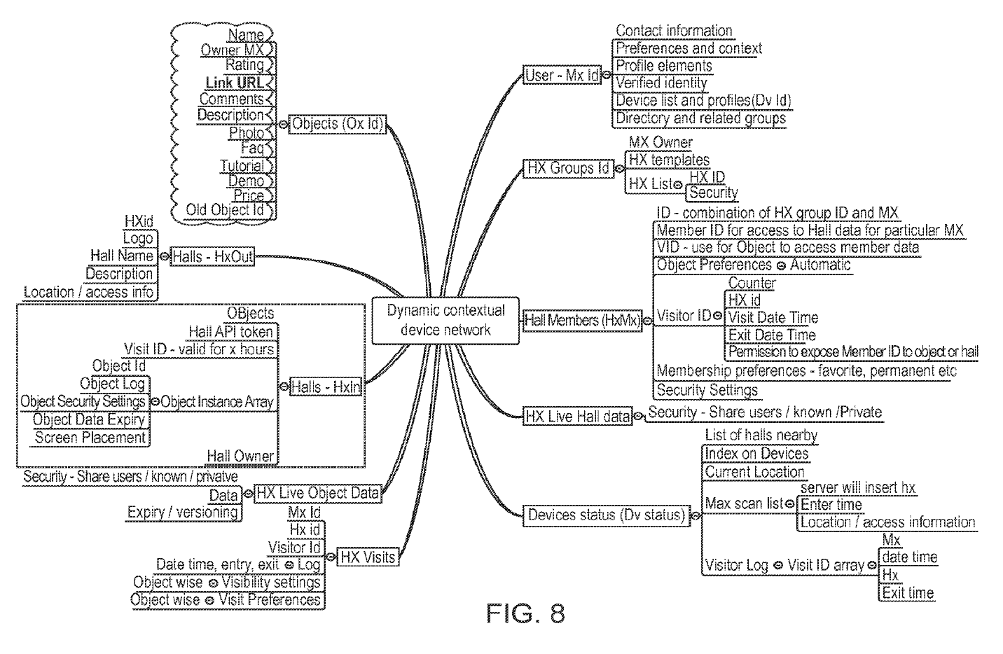

FIG. 8 provides further detail of Environment B by way of an illustration of a data structure according to one or more embodiments. Although shown as a NoSQL structure, other data structures may alternatively be used. Additionally, there may be other data included for other features, such as for security or DCDN ownership.

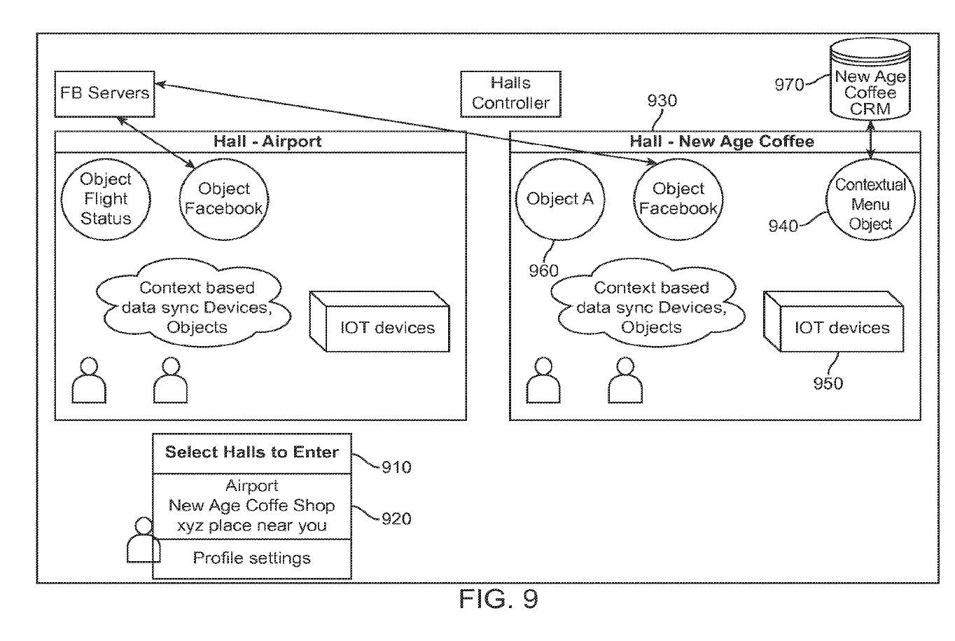

FIG. 9 provides further detail of Environment B by way of an example in block diagram form. In this example, a person may enter a New Age Coffee shop in an airport. An App 910 on the person's computing device provides a list 920 of available Virtual Halls (e.g., based on a signal signature), including a Virtual Hall 930 for the New Age Coffee shop and a Virtual Hall for the airport. The person may select (e.g., click an icon within the App) for the computing device to join a Virtual Hall, and if accepted, the computing device becomes a member of that Virtual Hall. Alternatively, upon entering, a computing device of the person automatically becomes a member of the New Age Coffee Virtual Hall 930 based on location (e.g., based on a signal signature such as the MAC ID of a New Age Coffee Wi-Fi device, on a Wi-Fi fingerprint within the New Age Coffee shop, or based on a GPS or triangulation position identification, which establishes that the computing device is within the VGS of the New Age Coffee Virtual Hall 930 according to the rules of the Virtual Hall 930).

Upon becoming a member, the computing device is provided information that is available in the New Age Coffee Virtual Hall 930, such as a menu (e.g., in the form of contextual menu object 940) for the particular physical location, objects related to equipment 950 in the New Age Coffee shop, a list of other locations, software applications available for download, persons who have chosen for their computing devices to be visible to other members of the New Age Coffee Virtual Hall 930, and other information. Meanwhile, information about the person or the associated computing device may be synchronized with other members of the New Age Coffee Virtual Hall 930. The person may select to order a drink directly through a received object 960 via the App, where the object 960 is, for example, information about a drink mixer machine (equipment). The drink mixer machine receives the order, accepts payment, mixes the requested drink, and notifies the person that the drink is ready. While in the New Age Coffee shop, the person's computing device may communicate with other members in the New Age Coffee Virtual Hall 930. When the person leaves the New Age Coffee shop (or, more specifically, the VGS of the New Age Coffee Virtual Hall 930), membership of the associated computing device in the New Age Coffee Virtual Hall 930 expires. Alternatively, once a computing device is a member of the New Age Coffee Virtual Hall 930, the computing device remains a member. Manual or automatic joining of a Virtual Hall may be dependent on user preferences or on rules associated with the corresponding DCDN. Thus, in the example of FIG. 9, the person may manually join one or more listed Virtual Hall, and the person's computing device may automatically join another. Further, the person's computing device may be in multiple Virtual Halls at the same time, thus, in the example of FIG. 9, the computing device may be a member of both the airport Virtual Hall and the New Age Coffee Virtual Hall 930.

A Virtual Hall may include objects that use the contextual data available in the Virtual Hall. For example, in the New Age Coffee Virtual Hall 930, the drink mixer machine may initiate interaction with the person's computing device based on device ID contextual information, such as by sending a message “may I prepare a drink for you,” and providing a list of drink options. Objects may further facilitate the functioning of other objects through parsing of contextual data that gets synchronized across devices. Objects may directly or indirectly access data of the Virtual Hall through API, connectors, data sync or other programming techniques. Objects may further retrieve data from third party customer relationship management (CRM, e.g., CRM 970) or enterprise resource planning (ERP) systems using network context data.

In one or more embodiments, when a computing device is eligible to be a member of each of multiple Virtual Halls, a list of available Virtual Halls is provided by App 910 in a prioritized fashion, such as being prioritized based on a three-dimensional proximity to a location, based on comparative signal strength of Wi-Fi devices establishing the related VGSs, or based on other context (e.g., preferences).

Environment C

Environment C is an extension of Environment A or Environment B.

In one or more embodiments, synch gateway 165 (FIG. 1B) receives contextual distribution security flags or settings in data packets, and provides synchronization accordingly. Synch gateway 165 may be a grid of distributed gateways, which in some embodiments may use a distributed database over many servers. Synch gateway 165 may process user context and credentials and pass them to appropriate objects automatically or on user selection.

Synch gateway 165 creates data channels for Virtual Halls, such as a data channel for the following example of a directory. The directory may be based on a group of contacts. Contacts in the group of contacts may have pre-verified credentials. Multiple applications and member computing devices are given access to the data channel to insert general data packets marked with distribution context for live synchronization (live sync), or marked with security restriction context. Distribution context and security restriction context may include identifications of users, computing devices, applications, sub-groups, or other identifications. Data packets may include configurations or code that are distributed within the channel based on context. Data packets may include automated expiry or deletion. A data packet may be formed by an SQL row or a NoSQL key value technique, or other such technique.

Packetization may follow a standard, and include meta-tags about the standard. A NoSQL database may be used to synchronize data between computing devices. Version control or conflict resolution may be built into data packets.

A directory may be formed dynamically, based on location or other context criterion/criteria. A directory may include applications, and may include objects.

In one or more embodiments, there may be a sub-channel of the data channel for each application or each device. An individual computing device or an application on a computing device (e.g. the Mobile Directory App) may filter out non-relevant data.

Environment D

In the embodiment of Environment D, a computing device can provide its location and/or a verified identity to a third party along with other context with a single click or action that captures a Virtual Insignia symbol and converts the symbol and the other context information into a form suitable for transmission. In one or more embodiments, by insignia computing device reading a Virtual Insignia, a website is automatically opened, with secure login automatically performed. Options may be provided based on a purpose of the Virtual Insignia, and may be related to a location or time, or to user preferences. This fast and simple-to-use technique provides for computing device verification without user input, other than perhaps initiating the reading of the Virtual Insignia (e.g., without user input such as first making a call, sending a code via SMS or text, or verifying ownership by confirming a link sent in an email). Another benefit to the quick and simple-to-use technique described is that it replaces the opening of many applications and websites separately, followed by logins for each.

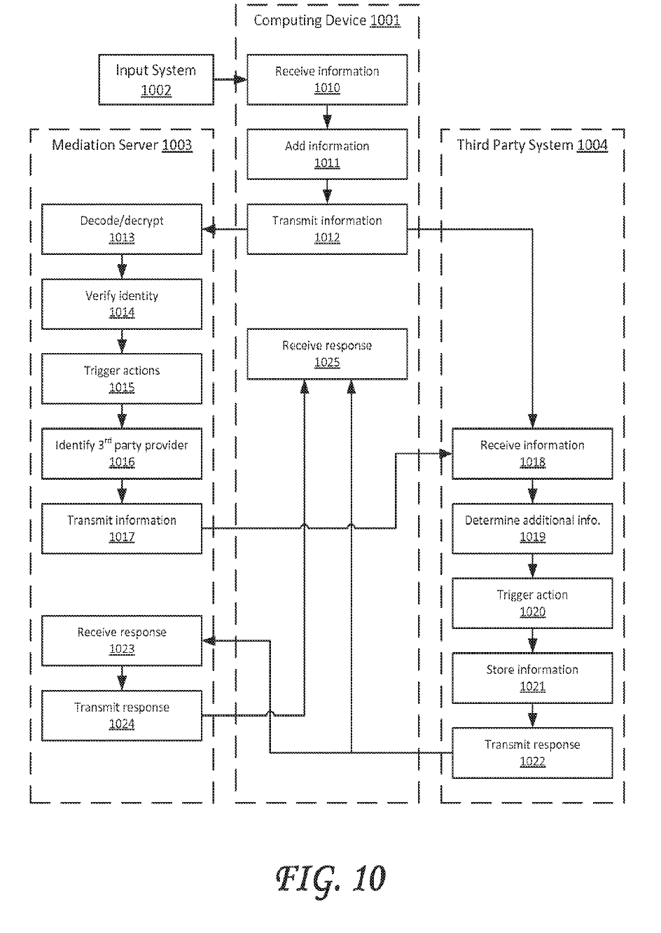

In the embodiment of Environment D, upon a trigger, the Virtual Insignia is read at or by the computing device. Reading the Virtual Insignia may be performed by a reader; for example, by a scanner, a QR reader, a Google glass, an application with user input, a microphone, a camera, or other sensing device. The Virtual Insignia is converted to digital data and may be supplemented with context information such as identity, location, preferences or other related information by an App, and is provided to a third party service provider (e.g., by way of API, http, or other technique). Alternatively, the Virtual Insignia information and supplemented information may be divided into multiple portions (e.g. divided by context, or divided into multiple transmissions), and provided to one third party service provider, or the portions provided to multiple third party service providers. Logs may be kept of Virtual Insignia reads, or of information provided to third parties. The third party service provider generates an output or action that is appropriate based on the Virtual Insignia and supplemented information. The communication between the computing device and the third party service provider may be tokenized for improved security. A server may be used to mediate the communication (see, e.g., the description of FIG. 10). The computing device may receive input back from a third party as part of workflow, or to trigger other actions or responses on the computing device.

A Virtual Insignia reader may have multiple identities, one of which may be used to trigger the reading of insignia Virtual Insignia. An identity may have more than one identifier, such as one or more mobile numbers, and/or one or more email addresses. The reader may have one or more passwords, and may have partial identifiers such as date of birth or last four digits of a Social Security number or bank account. Some or all of these identifiers may be passed on to a third party service provider based on context or request.

A list of context information to include in the information provided to a third party service provider may be determined by a trigger used. Such a list may include weather data, temperature, location, a Wi-Fi list, network details, credit card details, language preferences, eating habits, and allergies, for example. The trigger may require the list to be retrieved from the third party service provider or from another third party.

A list of approvals and trusted third party service providers may be kept with the reader to manage privacy concerns. Some embodiments are particularly useful with respect to symbols (e.g., a QR code, a bar code or other symbol). For example, presently the reading of a QR code triggers a URL to be opened, and further action is then expected of the user. As described in accordance with this disclosure, however, a QR code may instead directly log a customer into a customer account, and open a page or a transaction relevant to the context of the QR code. A corresponding App may be generalized across multiple third party companies so each does not have to create a customized App. Thus, rather than having to locate, download and open an appropriate App prior to scanning a QR code to trigger a custom App in a specific context, access to a target web site, page, or transaction is performed upon a single trigger, such as activating a QR reader. In one or more embodiments, a trigger also provides a pre-authentication to the third party service provider (see, e.g., the description of FIG. 10). In certain circumstances, a trigger may also trigger an authorization.

By way of another example, a Google glass may be the initiator of a trigger on object recognition, or by user initiation.

Identity of an initiator (or associated user) may or may not be fully disclosed to the third party service provider, and may instead be fully or partially concealed by way of hashing, encryption or compression.

In one or more embodiments, momentary contexts may be created temporarily by a reader or multiple linked readers. A momentary context may contain expiry information, such that the momentary context is removed automatically at the expiration of a time or at a change in location, for example. Such contexts may be added to subsequent triggers momentarily also. A trigger may be as simple as a user touch on a tablet, or as complex as a QR code embedded with pre-standardized instructions for trigger processing. The trigger could further route the trigger information to a preferred service provider included in predefined preferences.

As described above, a Virtual Insignia may be converted to a form suitable for transmission, which may include a hashing of the Virtual Insignia. For example, the Virtual Insignia may be a mobile number, and may be transmitted as a hash of a mobile number along with the country code. A computing device may use public key encryption to send data to a mediator service, which may then use another public key encryption to send trigger information and context data to a third party service provider. The third party service provider may then return output data to the computing device directly or indirectly (see, e.g., the description of FIG. 10).

In one or more embodiments, the information in a Virtual Insignia is standardized, and recognition is embedded in the trigger to channelize the information to a user-preferred third party service provider. For example, a blood report may be incorporated into a QR code that gets routed to the user-preferred personal health data repository.

In one or more embodiments, a method is published on a network (e.g., the Internet) to create standardized triggers compatible with localized readers. In one or more embodiments, triggers may be used to discover new choices or reduce the amount of choices available to a user. For example, there are presently are over a million applications for mobile devices and over a billion websites. It is increasingly daunting to know how to search for an appropriate website. The concepts of this disclosure make a search more reliable, easy and secure, and may save time by automating authentication.

In one or more embodiments, a common platform is provided, where the following scenario examples may be handled by configuring triggers on the platform:

User is in a restaurant 4 custom menu, queue management and alerts, ordering, invoicing User is at the airport 4 auto check-in, flight status User is in a shop/mall 4 best deals available User is in library 4 scan location of titles User is at school 4 notice board, time table, homework User is in an office 4 visitor management, access directories, track deadlines User is at home 4 single location of critical contacts, home automation User is at a public place 4 access to information, timings, parking or entry tickets, history, scores, etc.

There may also be automated pre-approved triggers in the platform, that may be used, for example, to switch on lights or for other automation. Context elements of a trigger may include but are not limited to: identity related information such as address, phone number, instant messaging (IM) identifier, and tweet handle; location; transmitter Id; Mac ID survey result; date; time; weather; preferences such as language, food, allergies, and theme; preferred software such as Quickbooks, Tally, Salesforce, or a health data bank; pre-selection such as table number, or bottle; direction of movement; historical data; group information; status; mobile device details; user input; photo; bar code; QR code; and payment information.

A trigger may further control the variations of context that are provided to a third party service provider. A trigger may include cascading triggers to accomplish multiple tasks.

In one or more embodiments, a common mobile platform is provided that captures and stores context elements, verified identities, and localized triggers for accessing multiple third party information services using multiple configurable triggers on a mobile computing device. The information accessed from a third party can include, but is not limited to, text, audio, video, scent, objects, or data streams or other binary data. The information accessed from a third party may further trigger context specific advertisements to be retrieved from the network (e.g., Internet) to show to a user of a Virtual Hall member device.

FIG. 10 illustrates an example of an embodiment of Environment D, in which a computing device 1001 receives input from an input system 1002, and communicates with a mediation server 1003 and a third party system 1004. Input system 1002 may be part of computing device 1001, or may be separate and in communication with computing device 1001, such as over a wired or wireless interface. Input system 1002 may include, for example, a reader such as a barcode reader, a QR code reader, a microphone, a camera, a user input mechanism such as a touchpad, keypad, or interactive display, or other reading device. Input system 1002 converts the information read to a form that may be used by computing device 1001, which form may be digital, analog, frequency, phase, or other form, or a combination thereof. After conversion of the information to a predefined format, input system 1002 provides the information to computing device 1001, which receives (at 1010) the information. Optionally, additional information may be added (at 1011) to the information from input system 1002. Additional information includes a user's pre-verified identity, a preferred third party service provider, user context, and user preferences, among other available additional information. Computing device 1001 transmits (at 1012) the information from input system 1002 and the additional information to mediation server 1003 and third party system 1004.

Mediation server 1003 receives the transmission and, if applicable, decodes or decrypts (at 1013) the received information. Mediation server 1003 then verifies (at 1014) the identity of the user of computing device 1001, triggers (at 1015) actions that may be identified based on the received information, such as determining context of the user, and identifies (at 1016) a server of a third party service provider. Mediation server 1003 transmits (at 1017) the user's context and other information to the identified server of the third party service provider (i.e., in third party system 1004).

Third party system 1004 receives (at 1018) both the transmission (at 1012) from computing device 1001 and the transmission (at 1017) from mediation server 1003. Third party system 1004 determines (at 1019) information to be used, such as based on the context of the user, triggers (at 1020) actions to be taken according to the determined information, and stores (at 1021) a portion of, or all of, the received information and the determined information. Third party system 1004 then transmits (at 1022) a response to computing device 1001 and mediation server 1003.

Mediation server 1003 receives (at 1023) the transmission from third party system 1004, and transmits (at 1024) a response to computing device 1001.

Computing device 1001 receives (at 1025) the transmission (at 1022) from third party system 1004 and the transmission (at 1024) from mediation server 1003. In this manner, by way of initiating a reading at input system 1002, a response to a request may be received at computing device 1001 without additional user input (i.e., no user input other than initiating a reading). In one or more embodiments, however, additional user input requests may be implemented.

Having described the concepts of this disclosure in overview, by analogy, and through environment examples, additional options are next discussed.

One of the issues that current location services and map digitizers face is the accuracy or fraud in crowd sourcing of information. People can claim any space on a map and there is no automatic way of determining who owns the location. One way to solve this issue is to deploy a specific hardware-based beacon that is encrypted and owned by someone. However, that is a costly solution and generates hardware rollout friction. Another way to solve this issue is to use existing beacons such as Wi-Fi for people to use to claim ownership. A problem with this solution is that someone could replicate the signal at another location. To overcome this problem, the beacon may be tied to a geographic location; then a person could establish ownership of a VGS at a location. The VGS ownership may be further detected by the ability of the user to login to an associated Wi-Fi connection.

Thus, for example, ownership of a virtual hall may be determined by verification information or credentials received from a computing device, by a relationship of a computing device and a transmitting device associated with the virtual hall, by a number of times that a computing device has been in the proximity of a transmitting device associated with the virtual hall, by a frequency that a computing device has been in the proximity of a transmitting device associated with the virtual hall, by a number of times that a computing device has entered the virtual hall, by a number of times that a computing device has submitted modifications to the virtual hall, by a percentage of context shared by a computing device and the definition of the virtual hall, and so forth.

Further, for the case in which multiple users nominate themselves to be the owner of a connected Wi-Fi, there may be a voting mechanism to establish an Administrator. Voting may include a variable weighted value based on time spent near the Wi-Fi source, longevity of membership in a Wi-Fi network, or daily check-ins, for example. Higher weight may also be given to a person who is able to reset the name of a service set identification (SSID). In this manner, the Administrator has a higher probability of having physical or fiduciary access to the location. In addition, a verification letter or code may be sent to the physical location via post for confirmation.

Another enhancement may be to tie a VGS to a domain ownership, making it easier to delegate management of ownership credentials. For example, such an enhancement prevents persons from fraudulently claiming to be a bank or a reputed name at a location by tying the VGS to a domain that can then be sent a code to verify, thereby certifying the ownership of the location.

In one or more embodiments, a device having a unique ID may be added to an application layer network through scanning or accepting a machine-readable code attached to a device containing the unique ID by another device belonging to a target data channel (e.g., of a Virtual Hall), and adding the device to the data channel of an application layer network of the onboarding device. Once the device is added to the network, the context of the device may be retrieved from a database containing the device context and circulated in the application layer network. For example, the context of an added device may include: a way to contact the device; application code to send instructions to the device; other information, access, restrictions, description, or manuals of the device; authentication or authorization; logs; device entity information like status, configuration, and options; or information about related entities such as manufacturer or part number. A device may have an embedded code to access data channel information on a real-time basis through an API or data synch technique.

Thus has been described system and techniques for quick and efficient access to information relevant to the context of a person or the person's computing device. As has been described, in one or more embodiments, context information of a user device (or the associated user) is provided to a remote computing device, and the remote computing device provides a list of virtual halls relevant to the context of the user device (or the associated user). In one or more embodiments, the list of virtual halls is prioritized based on relevance. In one or more embodiments, when the context information is location-based, the list of virtual halls may be prioritized based on proximity of the user device to a transmitting device of the virtual hall. The prioritized list may be presented as a group of icons to the user at a graphical user interface (GUI), and the user may select one of the icons to request access to (or become a member of) the virtual hall.

A determination of proximity may include determining a three-dimensional proximity, determining a proximity based on global positioning system (GPS) coordinates, or determining relative altitude between the computing device and a transmitting device associated with the virtual hall, for example.

Once a virtual hall has been accessed by a member, objects in the virtual hall may be provided to a GUI of the computing device.

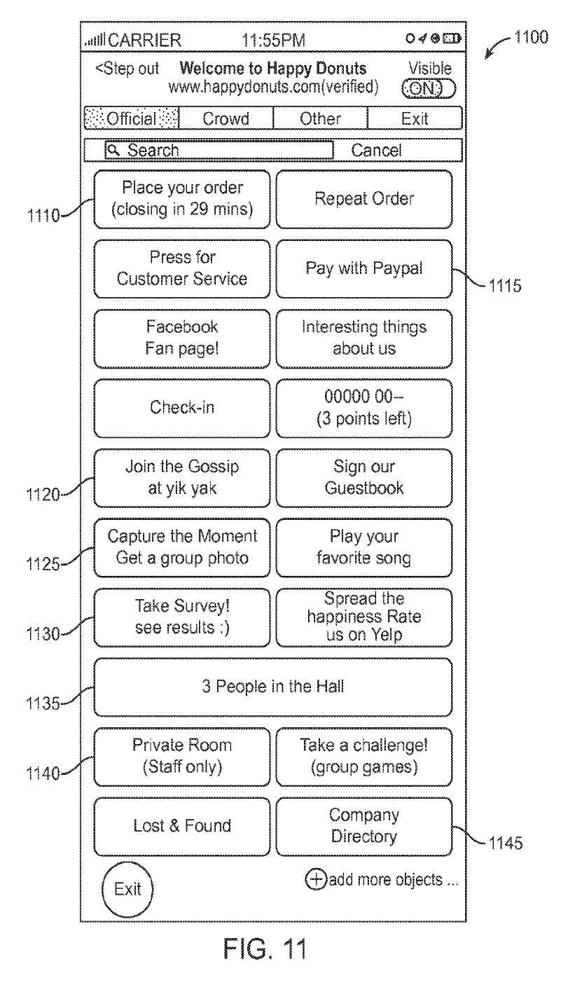

FIG. 11 provides an example of a presentation of objects in a virtual hall to a GUI 1100 of a mobile computing device. In this example, the objects relate to Happy Donuts, and include objects for activities that a user may participate in (e.g., gossip at 1120, take a group photo at 1125, or take a survey at 1130), objects or areas restricted to staff (e.g., the private room at 1140), objects including information about Happy Donuts (e.g., the company directory at 1145), objects including information about the virtual hall (e.g., number of members at 1135), objects for interaction with Happy Donuts (e.g., ordering at 1110), and objects for interaction with third parties (e.g., payment at 1115).

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. For example, the terms can refer to less than or equal to ±10%, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

While the disclosure has been described with reference to the specific embodiments thereof, it should be understood by those skilled in the art that various changes may be made and equivalents may be substituted without departing from the true spirit and scope of the disclosure as defined by the appended claims. In addition, many modifications may be made to adapt a particular situation, material, composition of matter, method, operation or operations, to the objective, spirit and scope of the disclosure. All such modifications are intended to be within the scope of the claims appended hereto. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations is not a limitation of the disclosure.

1. A system, comprising circuitry configured to establish and maintain:
a plurality of data channels; and
a plurality of virtual halls;
wherein each virtual hall:
is associated with one of the data channels,
includes data and objects related to the virtual hall, wherein the data includes context information related to devices or users; and
provides access to the data and objects to members of the virtual hall; and
wherein modifications to the data and objects of the virtual hall are synchronized between members of the virtual hall.

2. The system of claim 1, wherein the data and objects are accessible from an application layer via the Internet or via peer-to-peer communications between the members of the virtual hall.

3. (canceled)

4. A system, comprising circuitry configured to:
receive a virtual hall identifier and a request to create a virtual hall associated with the virtual hall identifier;
create a virtual hall;
establish a data channel for communication within the virtual hall;
provide a virtual insignia identifying the virtual hall;
receive a first request from a first device, the first request initiated by selection of the virtual insignia, the first request being to add the first device to the virtual hall;
identify a context of the first device;
verify that the context of the first device is consistent with rules associated with the virtual hall;
add the first device as a member of the virtual hall;
provide information about the virtual hall to the first device; and
update the virtual hall with information about the first device.

5. The system of claim 4, the circuitry further configured to:
receive a second request from a second device, the second request initiated by selection of the virtual insignia, the second request being to add the second device to the virtual hall;
identify a context of the second device;
verify that the context of the second device is consistent with rules associated with the virtual hall;
add the second device as a member of the virtual hall;
provide information about the virtual hall to the second device;
update the virtual hall with information about the second device; and
provide synchronization information to the first device, the synchronization information related to the second device.

6. The system of claim 5, the circuitry further configured to:
receive a request from the first device to distribute an electronic file to members of the virtual hall; and
provide the electronic file to members of the virtual hall.

7. The system of claim 5, the circuitry further configured to:
receive a request from the first device to distribute data to members of the virtual hall; and
provide the data to members of the virtual hall.

8. The system of claim 5, the circuitry further configured to:
receive a request from the first device to distribute data to members of the virtual hall; and
instruct the first device to distribute the data to the members of the virtual hall via a peer-to-peer network.

9. The system of claim 5, wherein the virtual insignia is a first virtual insignia and the virtual hall is a first virtual hall, the circuitry further configured to:
receive a third request from the first device, the third request initiated by selection of a second virtual insignia, the third request being to add the first device to a second virtual hall; and
copy the context of the first device to the second virtual hall.

10. The system of claim 4, wherein the virtual insignia is one of a media access control (MAC) address, a uniform resource locator (URL), an internet protocol (IP) address, or a telephone number.

11. The system of claim 10, wherein the data channel is accessed by a network unrelated to the virtual insignia.

12. The system of claim 4, wherein the virtual insignia is a biometric identifier selected from one of a fingerprint, an eye scan, a chemical profile, a heartbeat profile, or a voiceprint.

13. (canceled)

14. The system of claim 12, wherein the virtual hall is a private hall associated with an individual.

15. (canceled)

16. The system of claim 4, wherein the virtual hall is a public hall.

17. The system of claim 4, wherein the information about the virtual hall includes applications related to other devices in the virtual hall, and wherein the other devices in the virtual hall include at least one of a computing device, a printer, a scanner, a coffee machine, a video display, a television, and a telephone.

18. (canceled)

19. The system of claim 4, wherein the rules associated with the virtual hall are received with the request to create the virtual hall or are default rules or include no rules or include a requirement that all participants share a contact directory, and wherein the context of the first device includes information related to the shared contact directory.

20. (canceled)

21. (canceled)

22. (canceled)

23. The system of claim 4, wherein the context of the first device includes capabilities of the first device or includes a user associated with the first device or includes user preferences of a user associated with the first device or includes software applications stored on the first device or includes a location of the first device.

24. (canceled)

25. (canceled)

26. (canceled)

27. (canceled)

28. The system of claim 4, wherein identifying the context of the first device includes determining the location of the first device from at least one of a global positioning system (GPS) signal, triangulation, reception strength of a known signal source, and proximity to geo-locators.

29. The system of claim 4, wherein the context of the first device includes Wi-Fi networks available to the first device, the circuitry further configured to:
determine the location of the first device from one of a global positioning system (GPS) signal, triangulation, reception strength of a known signal source, proximity to geo-locators, or a combination thereof;
compare the determined location of the first device with a known location of at least one of the Wi-Fi networks available to the first device; and
in the case in which the determined location of the first device is greater than a predefined distance to the known location of the at least one of the Wi-Fi networks, reject the first request to add the first device to the virtual hall.

30. A method, comprising:
receiving a selection of a virtual insignia from a user interface of a first user device;
transmitting a representation of the virtual insignia to a remote computing device;
accepting from the remote computing device information related to a virtual hall associated with the virtual insignia;
providing context data to the remote computing device;
accepting synchronizing data, the synchronizing data related to a second user device entering the virtual hall; and
submitting data for distribution to participants of the virtual hall.

31. The method of claim 30, wherein the virtual insignia is any or a combination of a quick response (QR) code, a unique text string, a unique text string, media access control (MAC) address, a uniform resource locator (URL), an internet protocol (IP) address, a telephone number, or a biometric identifier selected from one of a fingerprint, an eye scan, a chemical profile, a heartbeat profile, or a voiceprint.

32. (canceled)

33. The method of claim 31, further comprising:
identifying Wi-Fi networks available to the user device; and
providing a list of the available Wi-Fi networks to be displayed at the user device;
wherein the unique text string is MAC address of an available Wi-Fi network.

34. The method of claim 30, wherein the submitted data is submitted via a peer-to-peer network to participants of the virtual hall.

35. The method of claim 30, wherein accepting the synchronizing data includes receiving synchronizing data from the second user device in the virtual hall via a peer-to-peer network or includes receiving synchronizing data from the remote computing device.

36. (canceled)

37. A method comprising:
providing location information of a user device to a remote computing device;
receiving from the remote computing device a list of virtual halls;
for each of the virtual halls in the list, determining a proximity of the user device to a transmitting device of the virtual hall;
prioritizing the list of virtual halls based on proximity;
providing a prioritized group of virtual insignias representing the prioritized list of virtual halls to a user interface of the user device; and
receiving a selection of one of the virtual insignias from the user interface.

38. The method of claim 37, wherein determining the proximity includes determining a three-dimensional proximity based on beacons or includes determining relative altitude based on global positioning system (GPS) coordinates.

39. (canceled)

40. (canceled)

41. The method of claim 37, further comprising receiving from the remote computing device an indication of ownership of the virtual hall based on a relationship of the user device to the transmitting device of the virtual hall associated with the selected virtual insignia or based on a number of times the user device has been, or a frequency of the user device being, in proximity to the transmitting device or another transmitting device associated with the virtual hall or based on a number of times the selected virtual insignia has been previously selected.

42. (canceled)

43. (canceled)

44. The method of claim 37, further comprising: providing verification of ownership of the transmitting device of a virtual hall, and receiving from the remote computing device an indication of ownership of the virtual hall based on the verification of ownership.
